(19) United States
(12) Patent Application Publication
(10) Pub. No.: US 2022/0278494 A1
(43) Pub. Date: Sep. 1, 2022

(54) PUNCHING HEAD FOR TERMINAL CRIMPING MACHINE

(71) Applicant: SHENZHEN CITY LINQUAN TECHNOLOGY CO., LTD, SHENZHEN (CN)

(72) Inventor: DONGLIN GAO, ZHOUKOU (CN)

(21) Appl. No.: 17/746,989

(22) Filed: May 18, 2022

Related U.S. Application Data
(63) Continuation of application No. PCT/CN2022/077697, filed on Feb. 24, 2022.

(30) Foreign Application Priority Data
Feb. 24, 2021 (CN) 202110206800.9

(51) Int. Cl. H01R 43/058; H01R 43/048

(52) U.S. Cl. CPC H01R 43/058; H01R 43/048; B21D 22/02

(57) ABSTRACT

A punching head for terminal crimping machine, includes a supporting device, a driving motor, a right-angle speed reducer, a first sliding rail, a second sliding rail, a sliding block, a stamping component, a turntable, an eccentric shaft, a driving disc, and a racetrack-shaped driving cavity. The driving motor is fixedly disposed on the supporting device, the right-angle speed reducer is connected to the driving motor, the first sliding rail is fixedly disposed on the supporting device, the second sliding rail is fixedly disposed on the supporting device and is opposite to the first sliding rail, the sliding block slides up and down between the first sliding rail and the second sliding rail, and the stamping component is disposed at a bottom of the sliding block and moves up and down along with the sliding block.

### TECHNICAL FIELD

The present disclosure relates to a field of machinery, and in particular to a punching head for terminal crimping machine.

### BACKGROUND

When crimping a terminal through a punching head, most of existing punching heads directly drive a punching head to reciprocate up and down through a driving motor to realize punching. According to this driving mode, the driving motor and the punching head need to be vertically disposed, so that an overall size of the punching head is large, which occupies a plurality of space and is not convenient for subsequent component on a machine table.

### SUMMARY

Aiming at defects in prior art, the present disclosure provides a punching head for terminal crimping machine.

The present disclosure provides the punching head for terminal crimping machine, including a supporting device, a driving motor, a right-angle speed reducer, a first sliding rail, a second sliding rail, a sliding block, a stamping component, a turntable, an eccentric shaft, a driving disc, and a racetrack-shaped driving cavity. The driving motor is fixedly disposed on the supporting device, the right-angle speed reducer is connected to the driving motor, the first sliding rail is fixedly disposed on the supporting device, the second sliding rail is fixedly disposed on the supporting device and is opposite to the first sliding rail, the sliding block slides up and down between the first sliding rail and the second sliding rail, and the stamping component is disposed at a bottom of the sliding block and moves up and down along with the sliding block. An output end of the driving motor is connected to an input end of the right-angle speed reducer, the turntable is disposed on an output shaft of the right-angle speed reducer and rotates with the output shaft of the right-angle speed reducer, the eccentric shaft is eccentrically disposed on the turntable, and the driving disc is rotatably sleeved on the eccentric shaft. The racetrack-shaped driving cavity, configured to accommodate the driving disc, is disposed on the sliding block. The driving disc rotates in the racetrack-shaped driving cavity and drives the sliding block to slide up and down along the first sliding rail and the second sliding rail.

Furthermore, the first sliding rail includes a first vertical guide rail, a first V-shaped sliding groove, a plurality of first roller pins, and a plurality of second roller pins. The first V-shaped sliding groove is defined on an inner side surface of the first vertical guide rail, the plurality of the first roller pins are rotatably disposed on a first side wall of the first V-shaped sliding groove, and the plurality of the second roller pins are rotatably disposed on a second side wall of the first V-shaped sliding groove.

Furthermore, the second sliding rail includes a second vertical guide rail, a second V-shaped sliding groove, a plurality of third roller pins, and a plurality of fourth roller pins. The second V-shaped sliding groove is defined on an inner side surface of the second vertical guide rail, the plurality of the third roller pins are rotatably disposed on a first side wall of the second V-shaped sliding groove, and the plurality of the fourth roller pins are rotatably disposed on a second side wall of the second V-shaped sliding groove.

Furthermore, a first V-shaped flange is disposed on a first side of the sliding block, and the first V-shaped flange is slidable within the first V-shaped sliding groove. A second V-shaped flange is disposed on a second side of the sliding block, and the second V-shaped flange is slidable within the second V-shaped sliding groove.

Furthermore, the sliding block includes a body, a first connecting portion, a second connecting portion, and a mounting position. The first connecting portion is fixedly disposed on a first side of a bottom of the body and protrudes from the bottom of the body. The second connecting portion is fixedly disposed on a second side of the bottom of the body and protrudes from the bottom of the body. The mounting position is disposed between the first connecting portion and the second connecting portion, and the mounting position is configured to fixedly mount the stamping component.

Furthermore, the stamping component includes a punching component and a connector, and the connector is connected with the punching component and the sliding block. A first vertical sliding groove is defined on a first side of the connector. The first connecting portion is partially embedded in the first vertical sliding groove and is further slidably connected with the first vertical sliding groove. A second vertical sliding groove is defined on a second side of the connector. The second connecting portion is partially embedded in the second vertical sliding groove and is further slidably connected with the second vertical sliding groove. A screw rod is disposed on the body, the screw rod vertically penetrates through the body and is in threaded connection with the connector. The screw rod drives the connector to slide up and down relative to the sliding block.

Furthermore, a nut is fixedly disposed at a top end of the screw rod, and a polygonal hole is defined on the nut or the nut is a polygonal nut.

A through hole is defined on the body, and the screw rod vertically penetrates through the through hole. A connecting hole is defined on an outer side surface of the body, and the connecting hole is communicated with the through hole. A crimping block is disposed in the connecting hole, the crimping block is configured to compress the screw rod, and the crimping block is connected to the body through a bolt.

Furthermore, the punching component at least includes a pressure sensor and a first punch. The pressure sensor is fixedly disposed between the first punch and the connector. The first punch includes a fixing portion, a first clamping block, and a second clamping block. The first clamping block is fixedly disposed on a first side of a bottom of the fixing portion, and the second clamping block is fixedly disposed on a second side of the bottom of the fixing portion. A first stop block is disposed on a bottom end of the first clamping block, and the first stop block extends toward a direction of the second clamping block. A second stop block is disposed on a bottom end of the second clamping block, and the second stop block extends toward a direction of the first clamping block. The first clamping block, the second clamping block, the first stop block, and the second stop block are clamped to form a fixing position for mounting a fixed mold.

Furthermore, the punching component further includes a vertical crimping rod fixedly connected with the connector, and the vertical crimping rod is fixedly connected to the connector through a connecting rod. At least one fixing hole is defined on the connecting rod. The crimping rod passes through the at least one fixing hole and is fixedly connected with the at least one fixing hole.

Furthermore, the punching component further includes a second punch, and the second punch is detachably connected to the first punch. The second punch includes a clamping block and a connecting column. The clamping block is fixedly clamped into the fixing position. The connecting column is fixedly disposed in a middle of a bottom surface of the clamping block and protrudes from the bottom surface of the clamping block. At least one annular groove recessed into the connecting column is defined on the connecting column, or a connecting disc is disposed on an end surface of a bottom end of the connecting column.

Furthermore, the supporting device includes a first supporting plate and a second supporting plate. The first supporting plate and the second supporting plate are respectively disposed on two sides of the driving motor. A fixing base is fixedly disposed between the first supporting plate and the second supporting plate, and the fixing base is fixedly connected with the first supporting plate and the second supporting plate. The first sliding rail and the second sliding rail are respectively disposed on two sides of the fixing base, or the first sliding rail and the second sliding rail are respectively disposed on an inner side surface of the first supporting plate and an inner side surface of the second supporting plate.

The fixing base is disposed between the right-angle speed reducer and the sliding block. A through hole is defined on the fixing base, and the turntable is rotated to penetrate through the through hole.

The punching head for terminal crimping machine of the present disclosure has following beneficial effects. When using the punching head of the present disclosure, the driving motor may be installed at a same angle as a sliding direction of the sliding block, and a rotating output of the driving motor is converted into rotation of the output shaft of the right-angle speed reducer through the right-angle speed reducer. In a rotating process of the output shaft of the right-angle speed reducer, the output shaft of the right-angle speed reducer drives the turntable to rotate, the turntable drives the eccentric shaft to rotate, and the eccentric shaft rotates and drives the driving disc to rotate in the driving cavity. Since the sliding direction of the sliding block is limited by the first sliding rail and the second sliding rail, in the process of the driving disc rotates in the driving cavity, the driving disc pushes the sliding block to slide up and down along the first sliding rail and the second sliding rail, and the sliding block drives the stamping component to crimp a terminal in the up-down moving process.

### BRIEF DESCRIPTION OF DRAWINGS

The present disclosure is further described below with reference to the accompanying drawings and embodiments, in which:

FIG. 1 is a first exploded structural schematic diagram of a punching head for terminal crimping machine of the present disclosure.

FIG. 2 is a second exploded structural schematic diagram of the punching head for terminal crimping machine of the present disclosure.

FIG. 3 is a third exploded structural schematic diagram of the punching head for terminal crimping machine of the present disclosure.

FIG. 4 is a component structural schematic diagram of the punching head for terminal crimping machine of the present disclosure.

FIG. 5 is a structural schematic diagram of a first sliding rail of the punching head for terminal crimping machine of the present disclosure.

### DETAILED DESCRIPTION

In order to make objectives, technical solutions and advantages of the present disclosure clearer, embodiments of the present disclosure may be further described in detail below with reference to accompanying drawings.

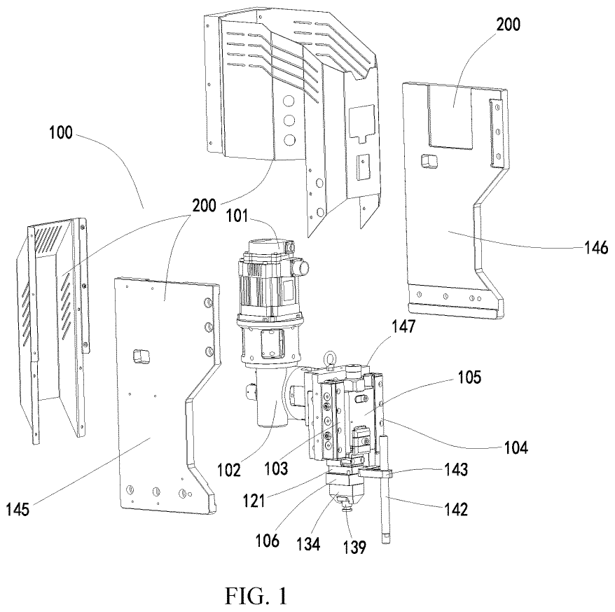

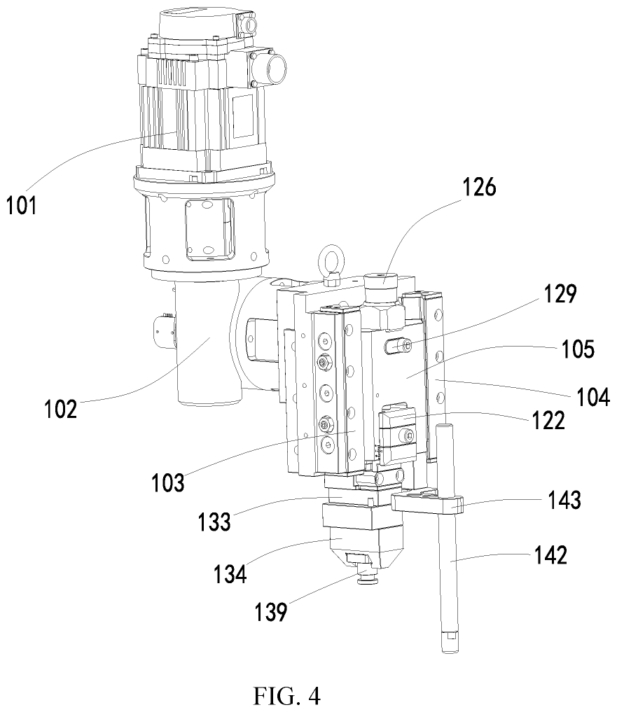

As shown in FIGS. 1-5, in the first embodiment of a punching head for terminal crimping machine of the present disclosure, the punching head 100 includes: a supporting device 200, a driving motor 101, a right-angle speed reducer 102, a first sliding rail 103, a second sliding rail 104, a sliding block 105, a stamping component 106, a turntable 107, an eccentric shaft 108, a driving disc 109, and a racetrack-shaped driving cavity 110. The driving motor 101 is fixedly disposed on the supporting device 200. The right-angle speed reducer 102 is connected to the driving motor 101. The first sliding rail 103 is fixedly disposed on the supporting device 200. The second sliding rail 104 is fixedly disposed on the supporting device 200 and is opposite to the first sliding rail 103. The sliding block 105 slides up and down between the first sliding rail 103 and the second sliding rail 104. The stamping component 106 is disposed at a bottom of the sliding block 105 and moves up and down along with the sliding block 105. An output end of the driving motor 101 is connected to an input end of the right-angle speed reducer 102. The turntable 107 is disposed on an output shaft of the right-angle speed reducer 102 and rotates with the output shaft of the right-angle speed reducer 102. The eccentric shaft 108 is eccentrically disposed on the turntable 107. The driving disc 109 is rotatably sleeved on the eccentric shaft 108. The racetrack-shaped driving cavity 110, configured to accommodate the driving disc 109, is disposed on the sliding block 105. The driving disc 109 rotates in the racetrack-shaped driving cavity 110 and drives the sliding block 105 to slide up and down along the first sliding rail 103 and the second sliding rail 104.

When using the punching head 100 of the present disclosure, the driving motor 101 may be installed at a same angle as a sliding direction of the sliding block 105, and then a rotating output of the driving motor 101 is converted into rotation of the output shaft of the right-angle speed reducer 102 through the right-angle speed reducer 102. In a rotating process of the output shaft of the right-angle speed reducer 102, the output shaft of the right-angle speed reducer 102 drives the turntable 107 to rotate, the turntable 107 drives the eccentric shaft 108 to rotate, and the eccentric shaft 108 rotates and drives the driving disc 109 to rotate in the driving cavity 110. Since the sliding direction of the sliding block 105 is limited by the first sliding rail 103 and the second sliding rail 104, in the process of the driving disc 109 rotates in the driving cavity 110, the driving disc 109 pushes the sliding block 105 to slide up and down along the first sliding rail 103 and the second sliding rail 104, and the sliding block 105 drives the stamping component 106 to crimp a terminal in the up-down moving process.

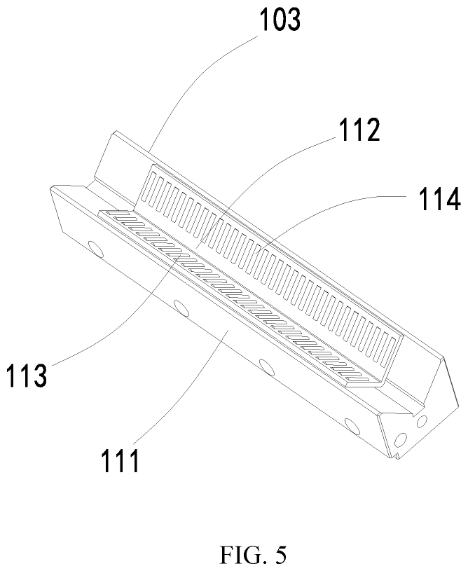

Specifically, as shown in FIG. 5, the first sliding rail 103 includes a first vertical guide rail 111, a first V-shaped sliding groove 112, a plurality of first roller pins 113, and a plurality of second roller pins 114. The first V-shaped sliding groove 112 is defined on an inner side surface of the first vertical guide rail 111. The plurality of the first roller pins 113 are rotatably disposed on a first side wall of the first V-shaped sliding groove 112, and the plurality of the second roller pins 114 are rotatably disposed on a second side wall of the first V-shaped sliding groove 112. The second sliding rail 104 includes a second vertical guide rail, a second V-shaped sliding groove 115, a plurality of third roller pins 116, and a plurality of fourth roller pins. The second V-shaped sliding groove 115 is defined on an inner side surface of the second vertical guide rail, the plurality of the third roller pins 116 are rotatably disposed on a first side wall of the second V-shaped sliding groove 115, and the plurality of the fourth roller pins are rotatably disposed on a second side wall of the second V-shaped sliding groove 115.

Furthermore, a first V-shaped flange 131 is disposed on a first side of the sliding block 105, and the first V-shaped flange 131 is slidable within the first V-shaped sliding groove 112. A second V-shaped flange 132 is disposed on a second side of the sliding block 105, and the second V-shaped flange 132 is slidable within the second V-shaped sliding groove 115.

During the up-down moving process of the sliding block 105, the first V-shaped flange 131 and the second V-shaped flange 132 respectively slide up and down in the first V-shaped sliding groove 112 and the second V-shaped sliding groove 115. Two side walls of the first V-shaped flange 131 and the second V-shaped flange 132 respectively abut against the first roller pins 113, the second roller pins 114, the third roller pins 116, and the fourth roller pins. Sliding of the sliding block is achieved through rotation of the first roller pins 113, the second roller pins 114, the third roller pins 116, and the fourth roller pins, which greatly reduces friction between the sliding block 105 and the first V-shaped sliding groove 112 and the second V-shaped sliding groove 115, thereby reducing power loss and improving punching force and stability of the punching head.

Specifically, the plurality of the first roller pins 113 are disposed in parallel to each other, the plurality of the second roller pins 114 are disposed in parallel to each other, the plurality of the third roller pins 116 are disposed in parallel to each other, and the plurality of the fourth roller pins are parallel to each other.

It may be understood that in other embodiments, the first sliding rail 103 and the second sliding rail 104 may further be other sliding rails, as long as the sliding rails play a role of guiding an up and down sliding of the sliding block 105.

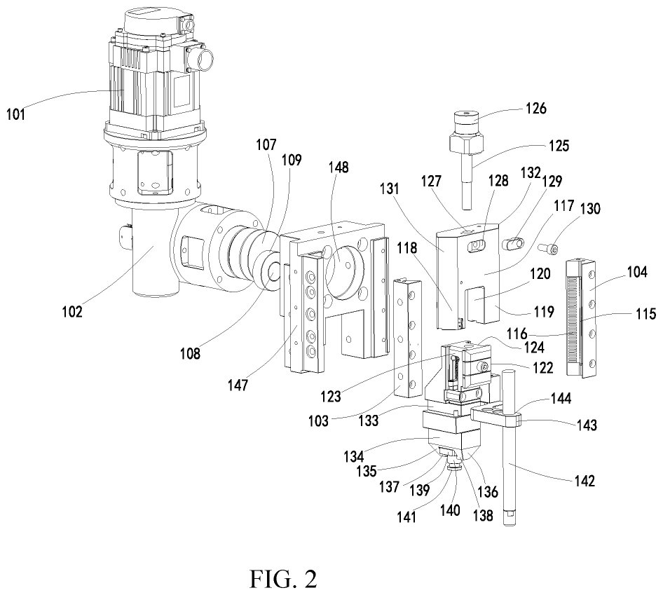

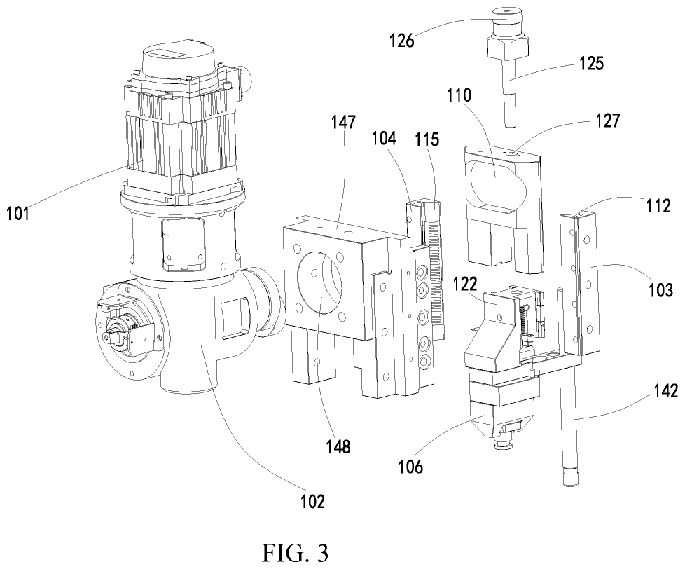

Specifically, as shown in FIG. 2-3, the sliding block 105 includes a body 117, a first connecting portion 118, a second connecting portion 119, and a mounting position 120. The first connecting portion 118 is fixedly disposed on a first side of a bottom of the body 117 and protrudes from the bottom of the body 117. The second connecting portion 119 is fixedly disposed on a second side of the bottom of the body 117 and protrudes from the bottom of the body 117. The mounting position 120 is disposed between the first connecting portion 118 and the second connecting portion 119, and the mounting position 120 is configured to fixedly mount the stamping component 106.

Furthermore, the stamping component 106 includes a punching component and a connector 122. The connector 122 is connected with the punching component and the sliding block 105. A first vertical sliding groove 123 is defined on a first side of the connector 122. The first connecting portion 118 is partially embedded in the first vertical sliding groove 123 and is further slidably connected with the first vertical sliding groove 123. A second vertical sliding groove 124 is defined on a second side of the connector 122. The second connecting portion 119 is partially embedded in the second vertical sliding groove 124 and is further slidably connected with the second vertical sliding groove 124. A screw rod 125 is disposed on the body 117, the screw rod 125 vertically penetrates through the body 117 and is in threaded connection with the connector 122, and the screw rod 125 drives the connector 122 to slide up and down relative to the sliding block 105.

Furthermore, a nut 126 is fixedly disposed at a top end of the screw rod 125. A polygonal hole is defined on the nut 126 or the nut 126 is a polygonal nut 126. A through hole 127 is defined on the body 117. The screw rod 125 vertically penetrates through the through hole 127. A connecting hole 128 is defined on an outer side surface of the body 117, and the connecting hole 128 is communicated with the through hole 127. A crimping block 129 is disposed in the connecting hole 128, the crimping block 129 is configured to compress the screw rod 125, and the crimping block 129 is connected to the body 117 through a bolt 130.

In the embodiment, a threaded hole is defined on a top of the connector 122, and the threaded hole allows a bottom end of the screw rod 125 to be inserted and screwed into the threaded hole.

When a height of the punching component needs to be adjusted, the nut is rotated to drive the screw rod 125 to rotate. Since two sides of the connector 122 are respectively slidably connected to the first connecting portion 118 and the second connecting portion 119, during rotation of the screw rod 125, the screw rod 125 drives the connector 122 to slide up and down along the first connecting portion 118 and the second connecting portion 119, thereby achieving height adjustment of the connector 122 and the punching component.

Specifically, as shown in FIG. 2-3, the punching component at least includes a pressure sensor 133 and a first punch 134. The pressure sensor 133 is fixedly disposed between the first punch 134 and the connector 122. The first punch 134 includes a fixing portion, a first clamping block 135, and a second clamping block. The first clamping block 135 is fixedly disposed on a first side of a bottom of the fixing portion. The second clamping block is fixedly disposed on a second side of the bottom of the fixing portion. A first stop block 137 is disposed on a bottom end of the first clamping block 135, and the first stop block 137 extends toward a direction of the second clamping block 136. A second stop block 138 is disposed on a bottom end of the second clamping block 136, and the second stop block 138 extends toward a direction of the first clamping block 135. The first clamping block 135, the second clamping block 136, the first stop block 137, and the second stop block 138 are clamped to form a fixing position for mounting a fixed mold.

When crimping a terminal, the mold is mounted on the fixing position between the first clamping block 135 and the second clamping block 136, and then the first punch 134 is driven through the driving motor 101 to crimp the terminal. Furthermore, through disposing the pressure sensor 133, pressure data in a crimping process of the terminal is detected, so that the punching head 100 may be adjusted.

Furthermore, the punching component further includes a vertical crimping rod 142 fixedly connected with the connector 122, and the vertical crimping rod 142 is fixedly connected to the connector 122 through a connecting rod 143. At least one fixing hole 144 is defined on the connecting rod 143. The crimping rod 142 passes through the at least one fixing hole 144 and is fixedly connected with the at least one fixing hole 144.

The punching component further includes a second punch 139, and the second punch 139 is detachably connected to the first punch 134. The second punch 139 includes a clamping block and a connecting column 140. The clamping block may be fixedly clamped into the fixing position. The connecting column 140 is fixedly disposed in a middle of a bottom surface of the clamping block and protrudes from the bottom surface of the clamping block. At least one annular groove recessed into the connecting column 140 is defined on the connecting column 140, or a connecting disc 141 is disposed on an end surface of a bottom end of the connecting column 140.

In the embodiment, through disposing the vertical crimping rod 142, the vertical crimping rod 142 moves up and down along with the punching component in the up-down moving process of the punching component, thereby realizing additional operation of cables. Furthermore, through disposing the second punch 139, molds with different structures are fixed through the second punch 139.

Specifically, the supporting device 200 includes a first supporting plate 145 and a second supporting plate 146. The first supporting plate 145 and the second supporting plate 146 are respectively disposed on two sides of the driving motor 101. A fixing base 147 is fixedly disposed between the first supporting plate 145 and the second supporting plate 146. The fixing base 147 is fixedly connected with the first supporting plate 145 and the second supporting plate 146. The first sliding rail 103 and the second sliding rail 104 are respectively disposed on two sides of the fixing base 147, or the first sliding rail 103 and the second sliding rail 104 are respectively disposed on an inner side surface of the first supporting plate 145 and an inner side surface of the second supporting plate 146. The fixing base 147 is disposed between the right-angle speed reducer 102 and the sliding block 105. A through hole 148 is defined on the fixing base 147, and the turntable 107 is rotated to penetrate through the through hole 148.

It may be understood that the first supporting plate 145 and the second supporting plate 146 are disposed on a machine table to integrally support and fix the punching head 100.

In addition, in the present disclosure, terms such as “connected”, “attached”, “stacked”, and the like should be understood broadly, for example, may be fixedly connected or detachably connected or integrated; may be directly connected or indirectly connected through an intermediate medium, or may be an interaction relationship between two or more elements inside the two elements. For a person with ordinary skill in art, specific meanings of the above terms in the present disclosure may be understood according to specific situations.

The above descriptions are merely embodiments of the present disclosure, and are not intended to limit patent scope of the present disclosure. Any equivalent structure or equivalent process transformation made through using the descriptions and drawings of the present disclosure, or directly or indirectly applied to other related technical fields, is intended to be included in the patent protection scope of the present disclosure.

What is claimed is:

1. A punching head for terminal crimping machine, comprising:
a supporting device (200);
a driving motor (101);
a right-angle speed reducer (102);
a first sliding rail (103);
a second sliding rail (104);
a sliding block (105);
a stamping component (106);
a turntable (107);
an eccentric shaft (108);
a driving disc (109); and
a racetrack-shaped driving cavity (110);
wherein the driving motor (101) is fixedly disposed on the supporting device (200), the right-angle speed reducer (102) is connected to the driving motor (101), the first sliding rail (103) is fixedly disposed on the supporting device (200), the second sliding rail (104) is fixedly disposed on the supporting device (200) and is opposite to the first sliding rail (103), the sliding block (105) slides up and down between the first sliding rail (103) and the second sliding rail (104), the stamping component (106) is disposed at a bottom of the sliding block (105) and moves up and down along with the sliding block (105); an output end of the driving motor (101) is connected to an input end of the right-angle speed reducer (102), the turntable (107) is disposed on an output shaft of the right-angle speed reducer (102) and rotates with the output shaft of the right-angle speed reducer (102), the eccentric shaft (108) is eccentrically disposed on the turntable (107), the driving disc (109) is rotatably sleeved on the eccentric shaft (108); the racetrack-shaped driving cavity (110), configured to accommodate the driving disc (109), is disposed on the sliding block (105); the driving disc (109) rotates in the racetrack-shaped driving cavity (110) and drives the sliding block (105) to slide up and down along the first sliding rail (103) and the second sliding rail (104).

2. The punching head for terminal crimping machine according to claim 1, wherein the first sliding rail (103) comprises a first vertical guide rail (111), a first V-shaped sliding groove (112), a plurality of first roller pins (113), and a plurality of second roller pins (114); wherein the first V-shaped sliding groove (112) is defined on an inner side surface of the first vertical guide rail (111), the plurality of the first roller pins (113) are rotatably disposed on a first side wall of the first V-shaped sliding groove (112), and the plurality of the second roller pins (114) are rotatably disposed on a second side wall of the first V-shaped sliding groove (112).

3. The punching head for terminal crimping machine according to claim 2, wherein the second sliding rail (104) comprises a second vertical guide rail, a second V-shaped sliding groove (115), a plurality of third roller pins (116), and a plurality of fourth roller pins; wherein the second V-shaped sliding groove (115) is defined on an inner side surface of the second vertical guide rail, the plurality of the third roller pins (116) are rotatably disposed on a first side wall of the second V-shaped sliding groove (115), and the plurality of the fourth roller pins are rotatably disposed on a second side wall of the second V-shaped sliding groove (115).

4. The punching head for terminal crimping machine according to claim 3, wherein a first V-shaped flange (131) is disposed on a first side of the sliding block (105), the first V-shaped flange (131) is slidable within the first V-shaped sliding groove (112); a second V-shaped flange (132) is disposed on a second side of the sliding block (105), and the second V-shaped flange (132) is slidable within the second V-shaped sliding groove (115).

5. The punching head for terminal crimping machine according to claim 1, wherein the sliding block (105) comprises a body (117), a first connecting portion (118), a second connecting portion (119), and a mounting position (120); wherein the first connecting portion (118) is fixedly disposed on a first side of a bottom of the body (117) and protrudes from the bottom of the body (117), the second connecting portion (119) is fixedly disposed on a second side of the bottom of the body (117) and protrudes from the bottom of the body (117); the mounting position (120) is disposed between the first connecting portion (118) and the second connecting portion (119), and the mounting position (120) is configured to fixedly mount the stamping component (106).

6. The punching head for terminal crimping machine according to claim 5, wherein the stamping component (106) comprises a punching component and a connector (122), the connector (122) is connected with the punching component and the sliding block (105); a first vertical sliding groove (123) is defined on a first side of the connector (122), the first connecting portion (118) is partially embedded in the first vertical sliding groove (123) and is further slidably connected with the first vertical sliding groove (123); a second vertical sliding groove (124) is defined on a second side of the connector (122), the second connecting portion (119) is partially embedded in the second vertical sliding groove (124) and is further slidably connected with the second vertical sliding groove (124); a screw rod (125) is disposed on the body (117), the screw rod (125) vertically penetrates through the body (117) and is in threaded connection with the connector (122), and the screw rod (125) drives the connector (122) to slide up and down relative to the sliding block (105).

7. The punching head for terminal crimping machine according to claim 6, wherein a nut (126) is fixedly disposed at a top end of the screw rod (125), a polygonal hole is defined on the nut (126) or the nut (126) is a polygonal nut (126); a through hole (127) is defined on the body (117), the screw rod (125) vertically penetrates through the through hole (127); a connecting hole (128) is defined on an outer side surface of the body (117), the connecting hole (128) is communicated with the through hole (127); a crimping block (129) is disposed in the connecting hole (128), the crimping block (129) is configured to compress the screw rod (125), and the crimping block (129) is connected to the body (117) through a bolt (130).

8. The punching head for terminal crimping machine according to claim 6, wherein the punching component at least comprises a pressure sensor (133) and a first punch (134), the pressure sensor (133) is fixedly disposed between the first punch (134) and the connector (122); the first punch (134) comprises a fixing portion, a first clamping block (135), and a second clamping block; the first clamping block (135) is fixedly disposed on a first side of a bottom of the fixing portion, the second clamping block is fixedly disposed on a second side of the bottom of the fixing portion; a first stop block (137) is disposed on a bottom end of the first clamping block (135), the first stop block (137) extends toward a direction of the second clamping block (136); a second stop block (138) is disposed on a bottom end of the second clamping block (136), the second stop block (138) extends toward a direction of the first clamping block (135); and the first clamping block (135), the second clamping block (136), the first stop block (137) and the second stop block (138) are clamped to form a fixing position for mounting a fixed mold.

9. The punching head for terminal crimping machine according to claim 8, wherein the punching component further comprises a vertical crimping rod (142) fixedly connected with the connector (122), and the vertical crimping rod (142) is fixedly connected to the connector (122) through a connecting rod (143), at least one fixing hole (144) is defined on the connecting rod (143), the crimping rod (142) passes through the at least one fixing hole (144) and is fixedly connected with the at least one fixing hole (144); the punching component further comprises a second punch (139), the second punch (139) is detachably connected to the first punch (134); the second punch (139) comprises a clamping block and a connecting column (140), the clamping block is fixedly clamped into the fixing position, the connecting column (140) is fixedly disposed in a middle of a bottom surface of the clamping block and protrudes from the bottom surface of the clamping block; and at least one annular groove recessed into the connecting column (140) is defined on the connecting column (140), or a connecting disc (141) is disposed on an end surface of a bottom end of the connecting column (140).

10. The punching head for terminal crimping machine according to claim 1, wherein the supporting device (200) comprises a first supporting plate (145) and a second supporting plate (146), the first supporting plate (145) and the second supporting plate (146) are respectively disposed on two sides of the driving motor (101); a fixing base (147) is fixedly disposed between the first supporting plate (145) and the second supporting plate (146), the fixing base (147) is fixedly connected with the first supporting plate (145) and the second supporting plate (146); the first sliding rail (103) and the second sliding rail (104) are respectively disposed on two sides of the fixing base (147), or the first sliding rail (103) and the second sliding rail (104) are respectively disposed on an inner side surface of the first supporting plate (145) and an inner side surface of the second supporting plate (146); the fixing base (147) is disposed between the right-angle speed reducer (102) and the sliding block (105); a through hole (148) is defined on the fixing base (147), and the turntable (107) is rotated to penetrate through the through hole (148).
